(19) United States
(12) Patent Application Publication
(10) Pub. No.: US 2008/0271673 A1
(43) Pub. Date: Nov. 6, 2008

(54) LIQUID SEND/RECEIVE JOINT DEVICE AND FUEL CELL SYSTEM USING THE SAME

(75) Inventors: Toru TAKAHASHI, Sagamihara-shi (JP); Junji OYAMA, Sagamihara-shi (JP); Makoto EBIKAWA, Sagamihara-shi (JP); Takuji MAYUZUMI, Sagamihara-shi (JP)

Correspondence Address: Studebaker & Brackett PC, 1890 Preston White Drive, Suite 105, Reston, VA, 20191, US

(73) Assignee: NIX, INC., Yokohama-shi (JP)

(21) Appl. No.: 11/940,572

(22) Filed: Nov. 15, 2007

(30) Foreign Application Priority Data
Nov. 17, 2006 (JP) 2006-311643

(51) Int. Cl. B05C 11/00

(52) U.S. Cl. 118/669

(57) ABSTRACT

A liquid send/receive joint device that releases pressure on a false connection prevention key and prevents breakage of the false connection prevention key when a rotary force of a predetermined level or greater is applied to the liquid send/receive joint device while a liquid accepter and a liquid reservoir are connected to each other, is provided. A fuel cell system equipped with such a liquid send/receive joint device is also provided.

The liquid send/receive joint device includes: a first joint member 10 having a male joint part 14; and a second joint member 50 that has a female joint part 54 to receive the male joint part 14 and is connected to the first joint member 10. The female joint part 54 has ribs 68A to 68D that are inserted into spaces between adjacent engagement protrusions 16A to 16D of the male joint part 14 when the female joint part 54 receives the male joint part 14. When a rotary force of a predetermined level or greater is applied to the liquid send/receive joint device with the ribs 68A to 68D inserted in the respective spaces and then the first joint member 10 rotates relative to the second joint member 50, the ribs 68A to 68D cause the engagement protrusions 16A to 16D to elastically distort and move relatively in the direction of rotation, and make each engagement protrusion 16A to 16D be inserted into another space.

### CROSS-REFERENCES TO RELATED APPLICATIONS

This application relates to and claims priority from Japanese Patent Application No. 2006-311643, filed on Nov. 17, 2006, the entire disclosure of which is incorporated herein by reference.

### BACKGROUND

1. Field of the Invention

The invention relates to a liquid send/receive joint device that is located between a liquid reservoir and a liquid accepter in a liquid supply means for, for example, a fuel cell or an ink-jet printer, and that guides a liquid contained in the liquid reservoir to the liquid accepter. This invention also relates to a fuel cell system equipped with such a liquid send/receive joint device.

2. Description of Related Art

Various liquid-using equipment, such as ink-jet printers, lighters and fuel cells using liquid fuel, and devices for chemical liquid administration for medical treatment that have a liquid accepter (liquid receiving means) for receiving and containing a liquid supplied externally have been widely used. Also, a liquid reservoir (liquid supply means) in various forms for discharging the liquid contained in the liquid-using equipment has been suggested as means for supplying the liquid to the above-described liquid accepter.

The major type of the liquid reservoir is a cartridge type that allows the liquid reservoir itself to be directly replaced with a new one when no liquid is left in the liquid reservoir. The cartridge-type liquid reservoir has the advantage that users can supply the liquid to the liquid accepter easily and very safely without dirtying their hands with the liquid. In particular, this is a very effective liquid supply means when the liquid to be supplied may have an adverse effect on the human body or may severely deteriorate if exposed to air.

Also, the development of fuel cells that generate electric power by using a liquid as fuel is being promoted these days. In particular, many electric-appliance makers are actively promoting the development of direct methanol fuel cells (DMFC), which use methanol as fuel. The DMFCs are expected to be new, next-generation batteries that can be used for, for example, notebook personal computers, various portable electronic devices, and cell phones. However, in general, methanol has a considerable effect on the human body. If a human inhales methanol, it may damage the central nervous system and cause dizziness and diarrhea. If a human inhales a large amount of methanol or methanol enters their eyes, the methanol may cause an optic nerve disorder and there is a high possibility of loss of sight. Accordingly, methanol is a highly dangerous toxic liquid. Therefore, in order to safely and easily supply fuel to general consumers of DMFCs, a means of supplying methanol to a liquid reservoir using a cartridge, without directly touching the methanol, is considered to be the optimum means, and the development of such a means is being widely promoted. (See, for example, Japanese Patent Application Laid-Open (Kokai) Publication No. 2003-305871, Japanese Patent Application Laid-Open (Kokai) Publication No. H8-12301, and Japanese Patent Application Laid-Open (Kokai) Publication No. 2003-317756).

In order to supply a liquid from the liquid reservoir to the liquid accepter, a liquid send/receive joint device is generally used, that sends/receives the liquid by connecting a liquid receiving port for the liquid accepter to a liquid supply port for the liquid reservoir in such a manner that they can be detached from each other whenever necessary (see Japanese Patent Application Laid-Open (Kokai) Publication No. H10-789, Japanese Patent Application Laid-Open (Kokai) Publication No. H8-50042, a Japanese translation of PCT international application (Tokuhyo) No. 2003-528699, Japanese Patent Application Laid-Open (Kokai) Publication No. 2003-266739, a Japanese translation of PCT international application (Tokuhyo) No. 2001-524896, Japanese Patent Application Laid-Open (Kokai) Publication No. 2000-289225, Japanese Patent Application Laid-Open (Kokai) Publication No. H7-68780, Japanese Patent Application Laid-Open (Kokai) Publication No. H5-254138, and Japanese Patent Application Laid-Open (Kokai) Publication No. 2003-331879).

A type of the liquid send/receive joint device described above that is child-proof, has a snap hook (also called “snap-fit”) mechanism and a false connection prevention key (mechanical key for prevention of false insertion) has been introduced as a mechanism that realizes, when the liquid accepter and the liquid reservoir are connected to each other, all of the following: an improvement in accuracy in the connection positions of both the liquid accepter and the liquid reservoir, secured fixation of the liquid accepter and the liquid reservoir, prevention of liquid leakage caused when a person such as a child mistakenly touches the liquid send/receive joint device, and prevention of false connection (i.e., prevention of connection of an incompatible liquid reservoir by mistake [for example, when the wrong liquid reservoir is connected to the liquid accepter]). This snap hook mechanism enables relatively easy fastening and unfastening and is inexpensive and lightweight. For example, the snap hook mechanism is composed of a pair of elements, one with a hook portion and the other with a receiving portion, like those called snaps and hooks.

However, when the liquid accepter and the liquid reservoir are connected to each other in the conventional liquid send/receive joint device using the snap hook mechanism with the false connection prevention key, if pressure is applied to rotate the liquid reservoir relative to the liquid accepter, there is a possibility that the false connection prevention key formed at the liquid send/receive joint part for the liquid accepter may break before the false connection prevention key formed at the liquid send/receive joint part for the liquid reservoir, depending on the size of the pressure. The liquid send/receive joint part placed at the liquid accepter is basically integrated with the main body of the electronic instrument and, therefore, should have a durability (life) similar to that of the main body of the electronic instrument. On the other hand, the liquid send/receive joint part placed at the liquid reservoir is replaced when no liquid to be supplied to the liquid accepter is left in the liquid reservoir. Therefore, a durability as high as that for the liquid send/receive joint part for the liquid accepter is not required for the liquid send/receive joint part for the liquid reservoir, but it is a reality that durability of a certain level or higher is required for the liquid send/receive joint part for the liquid reservoir. Consequently, there is a demand for a mechanism that releases the pressure on the false connection prevention key and prevents breakage of the false connection prevention key when a rotary force of a predetermined level or greater is applied to the liquid send/receive joint device to rotate the liquid reservoir relative to the liquid accepter.

### SUMMARY

The present invention was devised in light of the circumstances described above. It is an object of the invention to provide: a liquid send/receive joint device that can release the pressure on a false connection prevention key and prevent breakage of the false connection prevention key when a rotary force of a predetermined level or greater is applied to the liquid send/receive joint device with its liquid accepter and its liquid reservoir connected to each other and the liquid reservoir then rotates relative to the liquid accepter; and a fuel cell system equipped with such a liquid send/receive joint device.

In order to achieve the above-described object, a liquid send/receive joint device for connecting a liquid reservoir containing a liquid to a liquid accepter for receiving the liquid from the liquid reservoir is provided according to an aspect of the invention. This liquid send/receive joint device includes: a first joint member that has a male joint part and is placed at either of the liquid reservoir or the liquid accepter; and a second joint member that has a female joint part to receive the male joint part, is placed at the other of the liquid reservoir and the liquid accepter, and is connected to the first joint member when the female joint part receives the male joint part; wherein the male joint part has a plurality of engagement protrusions spaced apart from each other; and the female joint part has insertion parts to be respectively inserted into spaces between the adjacent engagement protrusions when receiving the male joint part; and wherein when a rotary force loss than a predetermined level is applied to the liquid send/receive joint device with the insertion parts inserted in the respective spaces and an attempt is made to rotate the first joint member relative to the second joint member, the insertion parts are locked by the engagement protrusions and the rotation of the insertion parts is thereby blocked; and when a rotary force of the predetermined level or greater is applied to the liquid send/receive joint device, the insertion parts are released from the state locked by the engagement protrusions and performs the rotation.

When the first joint member and the second joint member are connected to each other by having the male joint part for the first joint member received by the female joint part for the second joint member in the liquid send/receive joint device having the above-described configuration, each insertion part is inserted into the space between the adjacent engagement protrusions. Therefore, centering (positioning) of the first joint member and the second joint member can be performed, and the liquid send/receive joint device can have a false connection prevention key (mechanical key for false insertion prevention) function that makes the insertion parts enter into the respective spaces only if the combination of the first joint member and the second joint member is correct. Therefore, it is possible to prevent the wrong liquid from being supplied from the wrong liquid reservoir to the liquid accepter. Furthermore, the configuration is uncomplicated, the number of components is reduced, and downsizing is achieved.

When rotary force less than a predetermined level is applied to the liquid send/receive joint device while the insertion parts are inserted in the respective spaces, the insertion parts are locked by the engagement protrusions, thereby blocking rotation of the first joint member relative to the second joint member. However, when rotary force of the predetermined level or greater is applied to the liquid send/receive joint device, the insertion parts are released from the state locked by the engagement protrusions and rotation takes place. Therefore, even if the pressure is applied to the liquid send/receive joint device because of the rotation, it is possible to prevent breakage of the insertion parts.

Also, the liquid send/receive joint device according to an aspect of the invention can be configured so that the male joint part is made of an elastic element; and when the rotary force of the predetermined level or greater is applied to the liquid send/receive joint device, the insertion parts elastically distort the shape of the engagement protrusions, move the engagement protrusions relatively in the direction of rotation, and insert each of the engagement protrusions into a space other than the above located in the direction of rotation. Since the liquid send/receive joint device is configured as described above, when rotary force of the predetermined level or greater is applied to the liquid send/receive joint device and when an attempt is made to move the insertion parts in a direction of rotation, the engagement protrusions elastically change their shape, so that the pressure from the rotation on the engagement protrusions and the insertion parts can be dispersed, facilitating the movement of the insertion parts. As a result, even if the pressure is applied to the engagement protrusions and the insertion parts because of the rotation it is possible to prevent them from breaking due to their mutual pressing force.

Furthermore, the liquid send/receive joint device according to an aspect of the invention can be configured so that the engagement protrusions are located along the same circle and each engagement protrusion has an inside surface and an outside surface along the circle; and wherein when the rotary force of the predetermined level or greater is applied to the liquid send/receive joint device, the insertion parts change the shape of the engagement protrusions elastically so that the engagement protrusions lean inward, and the insertion parts move along the outside surfaces of the engagement protrusions. As a result, when rotation causes the insertion parts to move relatively in a direction of rotation, the engagement protrusions elastically change their shape and lean inward. When each insertion part is then inserted into another space located in the direction of rotation, the insertion parts elastically return to their original shape. As a result, the pressure from the rotation can be efficiently reduced, and the liquid send/receive joint device can be used repeatedly. Also, the pressure on the insertion parts can be reduced.

Moreover, the liquid send/receive joint device according to an aspect of the invention can be set so that the first joint member is placed at the liquid reservoir, the second joint member is placed at the liquid accepter, and the strength of the insertion parts is greater than that of the engagement protrusions. As a result, if the engagement protrusions are made of a material that does not elastically change its shape, and if the rotary force of the predetermined level or greater is applied to the liquid send/receive joint device, which will result in breakage of either the engagement protrusions or the insertion parts, the engagement protrusions formed on the first joint member placed at the liquid reservoir will break before the insertion parts formed on the second joint member placed at the liquid accepter. Therefore, the life (durability) of the second joint member can be extended (improved). Even if the engagement protrusions break in the above-described case, the engagement protrusions are provided to prevent false connection and, therefore, the breakage of the engagement protrusions will not influence sealability of the first joint member and the second joint member when they are connected. Consequently, the breakage of the engagement protrusions will not affect sending or receiving of the liquid.

The liquid send/receive joint device can be configured so that the female joint part has a hollow, generally-cylindrical receiving part for receiving the male joint part, and the insertion parts are ribs that protrude from the inside surface of the receiving part toward a central area of the receiving part. Because of the above-described configuration, the insertion parts (ribs) not only serve as the false connection prevention key as described above, but also serve to reinforce the female joint part.

Furthermore, the spaces between the adjacent engagement protrusions can be defined so that the width of each space on the inside surface side of the engagement protrusions is shorter than the width of the space on the outside surface side of the engagement protrusions. Also, the ribs can be configured so that the length of each rib along the periphery of the receiving part on its inside surface side is longer than the length of the opposite side of the rib closer to the central area of the receiving part. If the liquid send/receive joint device is configured as described above, when the rotary force of the predetermined level or greater is applied to the liquid send/receive joint device with the insertion parts inserted in the respective spaces and then the first joint member rotates relative to the second joint member, the insertion parts can move relatively in the direction of rotation more easily. As a result, the pressure from the rotation on the engagement protrusions and the insertion parts can be dispersed more efficiently.

The liquid send/receive joint device according to an aspect of the invention can be configured so that the first joint member is placed at the liquid reservoir and the second joint member is placed at the liquid accepter, a liquid supply part that has a liquid supply port and supplies the liquid from the liquid reservoir via the liquid supply port to the second joint member is placed at an approximately central area on the top-end side of the male joint part; and flanges that protrude toward near the periphery of the liquid supply port are formed at the respective top ends of the engagement protrusions. Therefore, in addition to the advantageous effects described earlier, the above-described configuration protects, with the engagement protrusions and the flanges, the liquid supply part for the first joint member placed at the liquid reservoir (such as a liquid cartridge), which may be often touched by users with their hands. As a result, even if any person, such as a child, touches this first joint member, it is possible to prevent malfunction of the liquid supply part (i.e., the first joint member is child-proofed).

Also, in the liquid send/receive joint device according to an aspect of the invention, the first joint member and the second joint member can be connected to each other with snap hooks so that they can be detached from each other whenever necessary. Therefore, in addition to the advantageous effects described earlier, the first joint member and the second joint member can be connected to each other more stably.

If the first joint member and the second joint member can be connected to each other with snap hooks so that they can be detached from each other whenever necessary, the liquid send/receive joint device can be configured so that first engagement parts are formed around the outside surface of the male joint part, and second engagement parts that engage with the first engagement part so that they can be detached from each other whenever necessary are formed around the inside surface of the female joint part; and engagement between the first engagement part and the second engagement part causes the first joint member and the second joint member to be connected to each other, while releasing the engagement between the first engagement part and the second engagement part disconnects the first joint member and the second joint member. As a result, the male joint part can serve as the snap-hook mechanism and the false connection prevention key and be child-proof, and the female joint part can also serve as the snap-hook mechanism and the false connection prevention key.

According to another aspect of the invention, a fuel cell system that includes: a fuel cell; a liquid reservoir containing liquid fuel; a liquid accepter for receiving the liquid fuel from the liquid reservoir and supplying it to the fuel cell; and the liquid send/receive joint device described above is provided.

Since the fuel cell system having the above-described configuration is equipped with the liquid send/receive joint device having the aforementioned advantageous effects, the configuration is uncomplicated, the number of components is reduced, and downsizing can be achieved; and when the rotary force of the predetermined level or greater is applied to the liquid send/receive joint device with the liquid reservoir and the liquid accepter connected to each other and then the liquid reservoir rotates relative to the liquid accepter, the pressure from the rotation on the engagement protrusions and the insertion parts can be released and breakage of the engagement protrusions and the insertion parts can be prevented. Therefore, the reliability of the fuel cell system will be enhanced. Incidentally, there is no particular limitation on the type of the liquid fuel, but the liquid fuel can contain, for example, methanol.

When the first joint member and the second joint member are connected to each other in the liquid send/receive joint device according to the present invention, false connection can be prevented by inserting the insertion parts into spaces formed between the adjacent engagement protrusions. Also, when the rotary force less than a predetermined level is applied to the liquid send/receive joint device with the insertion parts inserted in the respective spaces, the insertion parts are locked by the engagement protrusions; and when the rotary force of the predetermined level or greater is applied to the liquid send/receive joint device, the insertion parts are released from the state locked by the engagement protrusions and rotation takes place. Therefore, it is possible to prevent the insertion parts from being broken by the pressure from the rotation. As a result, a highly reliable liquid send/receive joint device whose configuration is uncomplicated and whose life can be extended, that has a reduced number of components, and for which downsizing is achieved can be provided.

Moreover, when liquid fuel is supplied from the liquid reservoir to the liquid accepter via the liquid send/receive joint/device in a fuel cell system according to another aspect of the invention, false connection can be prevented by inserting the insertion parts into spaces between the adjacent engagement protrusions formed on the liquid send/receive joint device. As a result, it is possible to prevent the wrong liquid from being supplied from the wrong liquid reservoir to the liquid accepter, and to enhance reliability. Even if the rotary force of the predetermined level or greater is applied to the liquid send/receive joint device with the insertion parts inserted in the respective spaces, it is possible to prevent the insertion parts from being broken by the pressure from the rotation. As a result, the life of the liquid send/receive joint device will be extended, and a high-performance and highly reliable fuel cell system can be provided.

### BRIEF DESCRIPTION OF THE DRAWINGS

FIG. 1 is a perspective view of a first joint member that is a component of a liquid send/receive joint device according to an embodiment of the present invention.

FIG. 2 is a perspective view of a second joint member that is a component of the liquid send/receive joint device according to the embodiment of the invention.

FIG. 3 is a cross-sectional view of the first joint member shown in FIG. 1 as taken along line III-III.

FIG. 4 is a cross-sectional view of the second joint member shown in FIG. 2 as taken along line IV-IV.

FIG. 5 is a cross-sectional view of the first joint member shown in FIG. 2 and the second joint member shown in FIG. 4 immediately before they are connected to each other.

FIG. 6 is a cross-sectional view of the first joint member shown in FIG. 2 and the second joint member shown in FIG. 4 when they are connected to each other.

FIG. 7 is a cross-sectional view of the first joint member and the second joint member, showing the state where a rotary force is externally applied to them while they are connected to each other.

FIG. 8 is a fragmentary cross-sectional view showing the state where the first joint member shown in FIG. 2 is placed in a housing for a liquid reservoir and the second joint member shown in FIG. 4 is connected to a housing for a liquid accepter.

FIG. 9 is a schematic diagram of a fuel cell system according to an embodiment of the invention.

### DETAILED DESCRIPTION OF PREFERRED EMBODIMENTS

A liquid send/receive joint device according to preferred embodiments of the invention, and a fuel cell system equipped with this liquid send/receive joint device will be described below with reference to the attached drawings. The embodiments described below are for the purpose of describing this invention, but the invention is not limited only to those embodiments. Accordingly, this invention can be utilized in various ways unless those utilizations depart from the gist of the invention.

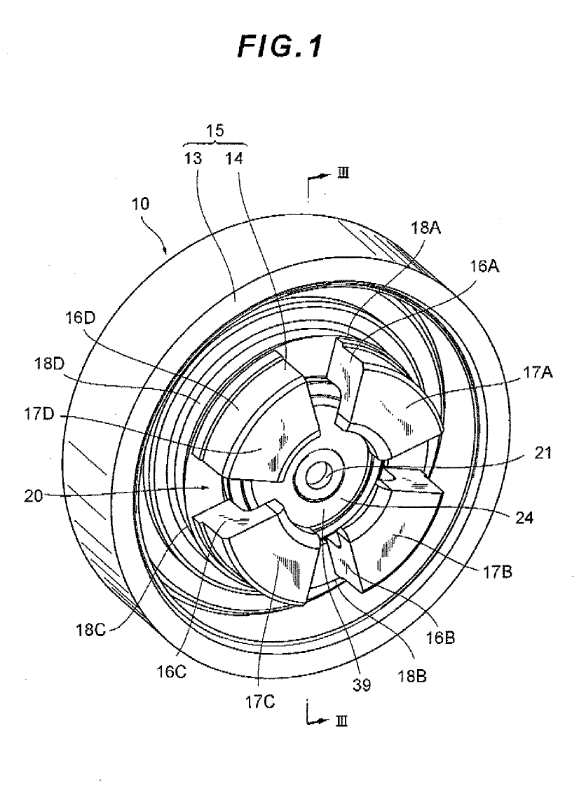

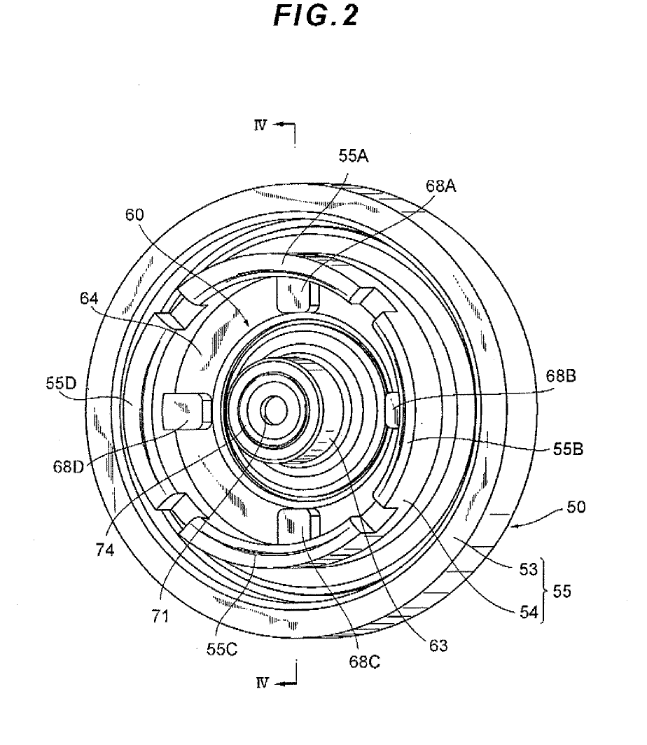

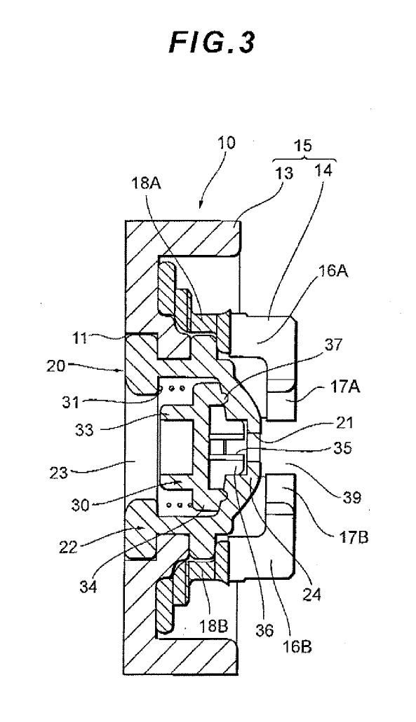

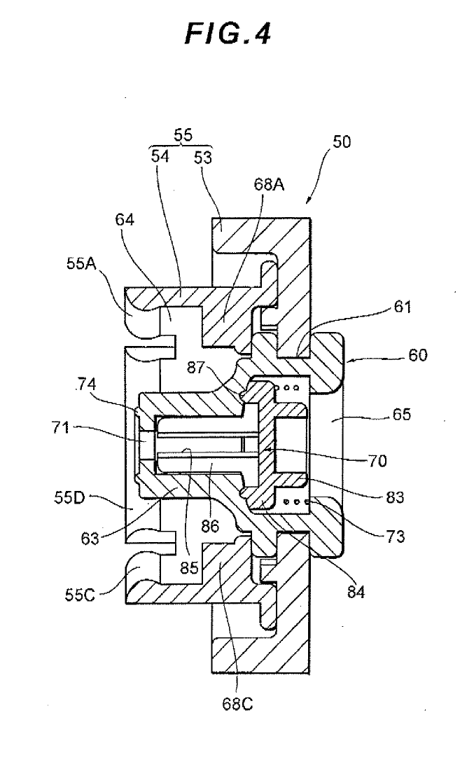

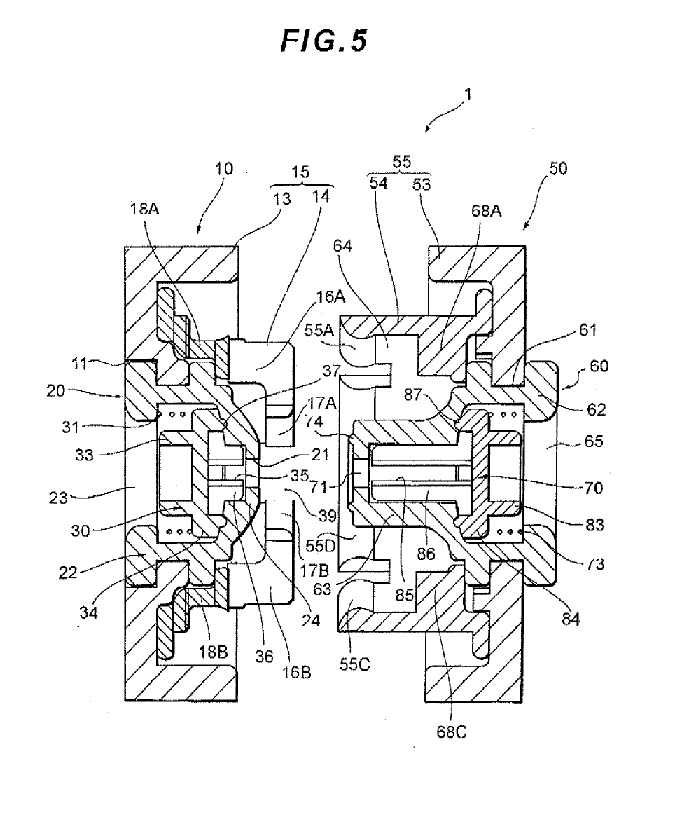

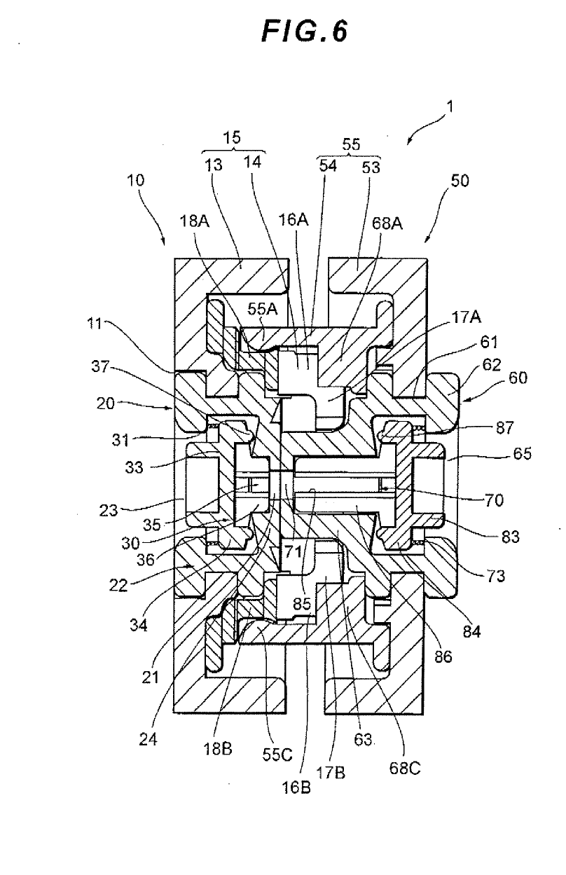

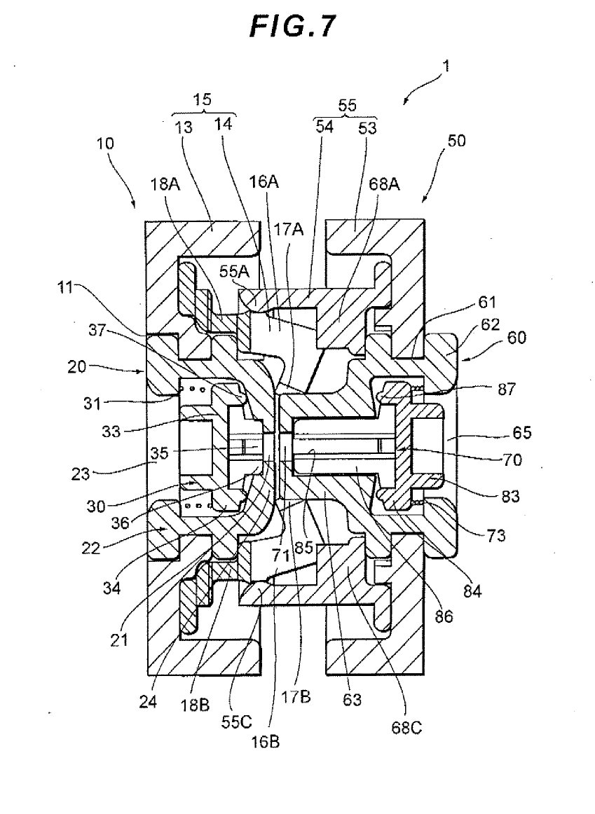

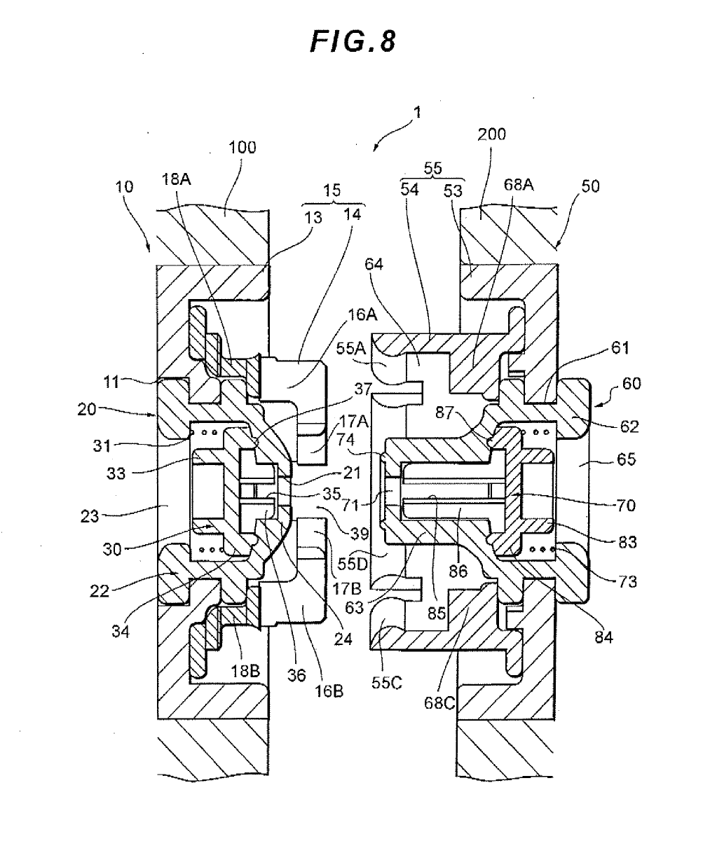

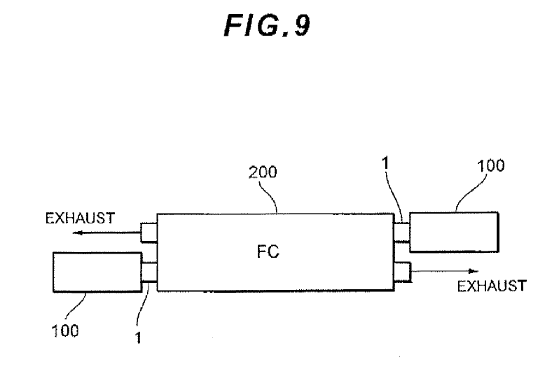

FIG. 1 is a perspective view of a first joint member that is a component of a liquid send/receive joint device according to an embodiment of the present invention. FIG. 2 is a perspective view of a second joint member that is a component of the liquid send/receive joint device according to the embodiment of the invention. FIG. 3 is a cross-sectional view of the first joint member shown in FIG. 1 as taken along line III-III. FIG. 4 is a cross-sectional view of the second joint member shown in FIG. 2 as taken along line IV-IV. FIG. 5 is a cross-sectional view of the first joint member shown in FIG. 2 and the second joint member shown in FIG. 4 immediately before they are connected to each other. FIG. 6 is a cross-sectional view of the first joint member shown in FIG. 2 and the second joint member shown in FIG. 4 when they are connected to each other. FIG. 7 is a cross-sectional view of the first joint member and the second joint member, showing the state where a rotary force is externally applied to them while they are connected to each other. FIG. 8 is a fragmentary cross-sectional view showing the state where the first joint member shown in FIG. 2 is placed in a housing for a liquid reservoir and the second joint member shown in FIG. 4 is connected to a housing for a liquid accepter. FIG. 9 is a schematic diagram of a fuel cell system according to an embodiment of the invention.

This embodiment will describe the case where a first joint member is placed in a housing for a liquid reservoir and a second joint member is placed in a housing for a liquid accepter. In this embodiment, one end of the first joint member placed in the housing for the liquid reservoir is referred to as the “base-end side,” while the other end of the first joint member to be connected to the second joint member is referred to as the “top-end side”; and one end of the second joint member placed in the housing for the liquid accepter is referred to as the “base-end side,” while the other end of the second joint member to be connected to the first joint member is referred to as the “top-end side.”

As shown in FIGS. 1 to 8, a liquid send/receive joint device 1 according to an embodiment of the invention includes: a first joint member 10 placed in a housing 100 for a liquid reservoir containing a liquid; and a second joint member 50 placed in a housing 200 for a liquid accepter for receiving the liquid supplied from the liquid reservoir. In this liquid send/receive joint device 1, the first joint member 10 placed in the housing 100 is connected with the second joint member 50 placed in the housing 200, thereby connecting the liquid reservoir and the liquid accepter and supplying the liquid contained in the liquid reservoir to the liquid accepter.

There is no particular limitation on the type of the liquid reservoir, and examples of the liquid reservoir include liquid fuel cartridges for liquid fuel, ink cartridges for liquid ink, and chemical liquid cartridges for chemical liquid. Also, there is no particular limitation on the type of the liquid accepter, and examples of the liquid accepter include: equipment such as fuel cells and lighters using liquid fuel supplied from liquid fuel cartridges; equipment such as printers using ink supplied from ink cartridges; and various kinds of medical equipment and laboratory-ware using chemical liquid supplied from chemical liquid cartridges.

If a fuel cell is used as the liquid accepter, the housing 200 for the fuel cell FC and the housing 100 for the liquid accepter containing the liquid fuel may be connected by the liquid send/receive joint device 1 as shown in FIG. 9. In this case, an example of the fuel cell as the liquid accepter is a direct methanol fuel cell (DMFC). The fuel cell includes: an electrolyte membrane made of, for example, perfluoro sulfonate polymer; an anode electrode provided on one side of the electrolyte membrane; a cathode electrode provided on the other side of the electrolyte membrane; and a pair of separators provided to hold both the electrodes between them. In this fuel cell system, fuel (methanol) supplied from a fuel cartridge, which is the liquid reservoir, to the fuel cell, which is the liquid accepter, is supplied to the anode electrode by, for example, a pump. On the other hand, oxygen is supplied to the cathode electrode by sending air from the atmosphere to the cathode electrode. In this case, it is desirable that an air blower mechanism composed of, for example, fans be provided somewhere in a passage to send the air to the cathode electrode, making it possible to increase the oxygen supply as necessary. Methanol and oxygen supplied in this manner generate electric power by means of a chemical reaction. After the chemical reaction, the methanol and oxygen are discharged as water or CO₂ from the fuel cell system.

The first joint member 10 includes: a first housing 15; and a liquid supply part 20 that is placed in an approximately central area of the first housing 15 and supplies the liquid from the liquid reservoir to the second joint member 50.

The first housing 15 is made of a material that can elastically change its shape to a certain degree, such as plastic, metal, rubber, or elastomer. The first housing 15 includes: a base 13 to be attached to the housing 100 for the liquid reservoir; and a male joint part 14 attached to the base 13.

An insertion hole 11 into which the base-end portion of a seal housing 22 for the liquid supply part 20 (described later in detail) is inserted is formed in an approximately central area of the base 13. The outside surface of the base-end portion of the seal housing 22 is fastened to the inside surface of the base 13 that defines this insertion hole 11.

The male joint part 14 has engagement protrusions 16A, 16B, 16C, and 16D formed by equally dividing a generally-annular protrusion rising up from the base 13 into four sections. Specifically speaking, each engagement protrusion 16A, 16B, 16C, and 16D has the same shape and they are located along the same circle and have their inside surfaces and outside surfaces placed along the circle. There are spaces between the adjacent engagement protrusions 16A and 16B, 16B and 16C, 16C and 16D, and 16D and 16A, into which ribs 68A, 68B, 68C, and 68D formed on the second joint member 50 (described later in detail) are optimally inserted respectively.

Regarding the first joint member 10, there is no particular limitation on the size, shape, and other factors for the spaces between the adjacent engagement protrusions 16A and 16B, 16B and 16C, 16C and 16D, and 16D and 16A as long as the rotation-direction movement of the ribs 68A, 68B, 68C, and 68D (described later in detail) which are inserted in the respective spaces can be blocked by the engagement protrusions 16A, 16B, 16C, and 16D unless a rotary force of a predetermined level or greater is applied to at least one of the first joint member 10 and the second joint member 50; and as long as when the rotary force of the predetermined level or greater is applied to at least one of the first joint member 10 and the second joint member 50, the ribs 68A, 68B, 68C, and 68D can move in the direction of rotation along the outside surfaces or the engagement protrusions 16A, 16B, 16C, and 16D and each rib 68A, 68B, 68C, and 68D can be inserted into the next space. The engagement protrusions 16A, 16B, 16C, and 16D may be configured so that the width of each space on the inside surface side of the engagement protrusions is almost equal to or slightly narrower than the width of the space on the outside surface side of the engagement protrusions.

Flanges 17A, 17B, 17C, and 17D that extend toward the approximately central area of the aforementioned circle and close to the periphery of the liquid supply port 21, which is formed on the top-end side of the liquid supply part 20 (described later in detail), are formed at and integrated with the top ends of the respective engagement protrusions 16A, 16B, 16C, and 16D. Each flange 17A, 17B, 17C, and 17D is of a fan-like shape with the length of its side closer to the approximately central area of the aforementioned circle is short and the length of the other side on its periphery is long. A generally-circular hole (space) 39 defined, in the approximately central area of the aforementioned circle, by the flanges 17A, 17B, 17C, and 17D is designed to have a small diameter of about, for example, 1 mm. As a result, even if a child or any other person touches the first joint member 10, the flanges 17A, 17B, 17C, and 17D serve as a cover that prevents that person from touching the liquid supply part 20 (described later in detail) and so it is child-proof. Also, engagement parts 18A, 18B, 18C, and 18D that engage with engagement hooks 55A, 55B, 55C, and 55D formed on the second joint member 50 (described later in detail) are formed around the outside surfaces of the engagement protrusions 16A, 16B, 16C, and 16D.

Incidentally, the liquid supply part 20 is placed in a space defined by the inside wall of the base 13 and the inside wall of the male joint part 14.

The liquid supply pad 20 includes: a seal housing 22 fastened to the inside wall of the first housing 15; a first valve element 30 placed in the seal housing 22 so that the first valve element 30 can move within the seal housing 22; and a coil spring 31 with its one end fastened to the inside wall of the seal housing 22 and the other end fastened to the first valve element 30.

The seal housing 22 is made of an elastic material such as rubber or elastomer. The base-end side of the seal housing 22 is fastened to the first housing 15, and the top-end portion of the seal housing 22 constitutes a generally-hemispherical curved face 24. A liquid receiving port 23 for receiving the liquid contained in the liquid reservoir into the seal housing 22 is formed in an approximately central area of the base-end side of the seal housing 22. On the other hand, a liquid supply port 21 for supplying the liquid, which has entered the seal housing 22 to the second joint member 50 is formed in an approximately central area of the curved face 24. Inside this seal housing 22, there is a space in which the first valve element 30 is placed so that it can be moved by force applied by the coil spring 31. When the first valve element 30 (described later in detail) comes into close contact with the seal housing 22, the seal housing 22 seals a space between itself and the first valve element 30; and when the first joint member 10 and the second joint member 50 are connected to each other, the seal housing 22 seals a space between itself and a liquid receiving port 71 (described later in detail) of the second joint member 50.

The first valve element 30 includes: a cylindrical part 33 to be inserted into the liquid receiving port 23 when the first valve element 30 moves to the base-end side; a flange 34 formed on and integrated with the top-end side of the cylindrical part 33; and a liquid passage forming part 36 that protrudes from an approximately central area of a top-end face of the flange 34, and in which a passage 35 for passing the liquid is formed. A labyrinth seal 37 that protrudes in a generally ring-like shape is formed on the surface of the flange 34 around the periphery of the liquid passage forming part 36. When the first valve element 30 comes into contact with the inside wall of the seal housing 22, the seal housing 22 seals the space between them with certainty. Also, one end of the coil spring 31 is fastened to the base-end face of the flange 34. As shown in FIGS. 3, 5, and 8, the first valve element 30 is normally pressed against the top-end side of the seal housing 22 by the force applied by the coil spring 31, thereby closing the liquid passage extending from the liquid receiving port 23 to the liquid supply port 21. For this coil spring 31, a spring coil capable of applying greater force than that applied by a coil spring 73 to a second valve element 70 (described later in detail) is used.

The second joint member 50 includes: a second housing 55, and a liquid supply part 60 that is placed in an approximately central area in the second housing 55 and receives the liquid supplied from the first joint member 10 and supplies it to the liquid accepter.

The second housing 55 is made of a material such as plastic, metal, or elastomer. The second housing 55 includes: a base 53 to be attached to a housing 200 for the liquid accepter; and a female joint part 54 attached to the base 53.

An insertion hole 61 into which the base-end portion of a seal housing 62 for a liquid supply part 60 (described later in detail) is formed at an approximately central area of the base 53. The outside surface of the base-end portion of the seal housing 62 is fastened to the inside surface of the base 53 that defines the insertion hole 61.

The female joint part 54 has, in its approximately central area, a generally cylindrical recess 64 that can accommodate the male joint part 14. The male joint part 14 side of the side wall of the female joint part 54 defining the recess 64 is divided into four sections that are equally spaced apart. Engagement hooks 55A, 55B, 55C, and 55D that engage with the engagement parts 18A, 18B, 18C, and 18D formed at the male joint part 14 are formed at the top ends of the respective four divided sections. When the first joint member 10 and the second joint member 50 are connected to each other, the male joint part 14 is placed in the female joint part 54 and the engagement hooks 55A, 55B, 55C, and 55D engage with the engagement parts 18A, 18B, 18C, and 18D respectively so that they can be detached from each other whenever necessary. Accordingly, the engagement hooks 55 and the engagement parts 18 can be attached to or detached from each other in a snap-hook manner whenever necessary. Specifically speaking, according to this embodiment, the engagement parts 18A, 18B, 18C, and 18D constitute snap-hook parts of the first joint member 10, while the engagement hooks 55A, 55B, 55C, and 55D constitute snap-hook parts of the second joint member 50. Incidentally, the liquid supply part 60 is placed in a space defined by the inside wall of the base 53 and the inside wall of the female joint part 54.

The ribs 68A, 68B, 68C, and 68D that protrude inwardly are formed on the inside surface of the base-end side of the female joint part 54. When connecting the first joint member 10 and the second joint member 50 together, these ribs 68A, 68B, 68C, and 68D are respectively inserted into spaces between the adjacent engagement protrusions 16A and 16B, 16B and 16C, 16C and 16D, and 16D and 16A at the male joint part 14. The shape of each rib 68A, 68B, 68C, and 68D is complementary to that of each space. The ribs 68A, 68B, 68C, and 68D are inserted into the respective spaces only when the combination of the first joint member 10 and the second joint member 50 is correct. In other words, the ribs 68A, 68B, 68C, and 68D serve as a false connection prevention key (mechanical key for prevention of false insertion). If the correct liquid reservoir is not selected for the liquid accepter, the ribs 68A, 68B, 68C, and 68D will not be properly inserted into the respective spaces; and it is possible to prevent the wrong liquid from being supplied from the wrong liquid reservoir to the liquid accepter. Incidentally, these ribs 68A, 68B, 68C, and 68D also serve to reinforce the side wall of the female joint part 54 that defines the recess 64.

Unless a rotary force of a predetermined level or greater is applied to at least one of the first joint member 10 and the second joint member 50, the movement of the ribs 68A, 68B, 68C, and 68D in the direction of rotation is blocked by the engagement protrusions 16A, 16B, 16C, and 16D and the relative rotation of the first joint member 10 and the second joint member 50 is limited. On the other hand, if the rotary force of the predetermined level or greater is applied to at least one of the first joint member 10 and the second joint member 50 (as described later in detail), the ribs 68A, 68B, 68C, and 68D press the outside surfaces of the engagement protrusions 16A, 16B, 16C, and 16D located in the direction of rotation toward their inside surfaces. This pressing force makes the engagement protrusions 16A, 16B, 16C, and 16D lean inward because of their elasticity; the ribs 68A, 68B, 68C, and 68D move in the direction of rotation along the outside surfaces of the engagement protrusions 16A, 16B, 16C, and 16D; each rib 68A, 68B, 68C, and 68D is then inserted into the next space; and the engagement protrusions 16A, 16B, 16C, and 16D return to their original position (shape) because of their elasticity/elastic nature.

The liquid supply part 60 includes: a seal housing 62; a second valve element 70 placed in the seal housing 62 so that the second valve element 70 can move within the seal housing 62; and a coil spring 73 with its one end fastened to the inside wall of the seal housing 62 and the other end fastened to the second valve element 70.

The seal housing 62 is made of a material similar to that for the seal housing 22. The base-end side of the seal housing 62 is fastened to the second housing 55, and the top-end portion of the seal housing 62 constitutes a hollow, cylindrical part 63. A liquid supply port 65 for supplying the liquid to the liquid accepter is formed in an approximately central area of the base-end side of the seal housing 62. On the other hand, a liquid receiving port 71 for receiving the liquid supplied from the first joint member 10 is formed in an approximately central area of the top-end face of the cylindrical part 63. A labyrinth seal 74 is formed around the periphery of the liquid receiving port 71. In the seal housing 62, there is a space in which the second valve element 70 is placed so that it can be moved by the force applied by the coil spring 73. When the second valve element 70 comes into close contact with the seal housing 62, the seal housing 62 seals the space between itself and the second valve element 70; and when the first joint member 10 and the second joint member 50 are connected to each other, the seal housing 62 seats a space between itself and the liquid supply port 21 for the first joint member 10.

The second valve element 70 includes: a cylindrical part 83 to be inserted into the liquid supply port 65 when the second valve element 70 moves to the base-end side; a flange 84 formed on and integrated with the top-end side of the cylindrical part 83; and a liquid passage forming part 86 that protrudes from an approximately central area of a top-end face of the flange 84, and in which a passage 85 for passing the liquid is formed. A labyrinth seal 87 that protrudes in a generally-ring shape is formed on the surface of the flange 84 around the periphery of the liquid passage forming part 86. When the second valve element 70 comes into contact with the inside wall of the seal housing 62, the seal housing 62 seals the space between them with certainty. Also, one end of the coil spring 73 is fastened to the base-end face of the flange 84. As shown in FIGS. 4, 5, and 8, the second valve element 70 is normally pressed against the top-end side of the seal housing 62 by the force applied by the coil spring 73, thereby closing the liquid passage extending from the liquid receiving port 71 to the liquid supply port 65. For this coil spring 73, a spring coil capable of applying smaller force than that applied by the coil spring 31 to the first valve element 30 is used.

Examples of plastics used to form the first housing 15 and the second housing 55 include: polyethylene, polypropylene, polyvinyl chloride resin, polystyrene, ABS resin, methacrylic resin, polyethyleneterephthalate, polyamide, polycarbonate, polyacetal, polybutylene terephthalate, modified polyphenylene ether, polyphenylene sulfide, liquid crystal polymer, polysulfone, polyether sulfone, polyallylate, polyether ether ketone, polyphthal amide, polyimide, polyether-imide, polyamide-imide, polymethyl pentene, fluororesin, polyvinylidene fluoride, TEFE, PFA, phenolic resin, urea resin, melamine resin, unsaturated polyester, diallyl phthalate, epoxy resin, polyurethane resin, and silicon resin. In this embodiment, polypropylene, which is highly resistant to methanol, is used in consideration of the fact that it is used in a DMFC.

As the material for the seat housings 22 and 62, various known elastic materials such as rubber and elastomers can be used. Specific examples of the elastic materials include: styrene butadiene rubber, butadiene rubber, syndiotactic 1,2-polybutadiene, isoprene rubber, acrylonitrile-butadiene rubber, chloroprene rubber, ethylene-propylene rubber, ethylene-propylene terpolymer, butyl rubber, acrylic rubber, chlorosulfonated polyethylene, silicon rubber, vinylidene fluoride rubber, tetrafluoroethylene-propylene rubber, tetrafluoroethylene perfluoromethyl vinyl ether rubber, fluorosilicon rubber, epichlorohydrin rubber, polysulfide rubber, urethane rubber, and natural rubber. These rubber types can be used alone, or in combination.

Specific operations of the liquid send/receive joint device 1 according to this embodiment will be described below.

In order to supply the liquid contained in the liquid reservoir, where the first joint member 10 is placed, to the liquid accepter, where the second joint member 50 is placed, the male joint part 14 of the first joint member 10 is first inserted into the female joint part 54 of the second joint member 50. At this point in time, the top-end portion of the male joint part 14 is first inserted into the recess 64 of the female joint part 54, and the top-end portion of the cylindrical part 63 of the seal housing 62 enters the first housing 15 through the generally-circular hole 39 defined by the flanges 17A, 17B, 17C, and 17D and comes into contact with the curved face 24 of the seal housing 22.

If the male joint part 14 in the above-described state is further inserted into the female joint part 54, the seal housing 22 and the seal housing 62 begin to press each other. When this happens, since the force applied by the coil spring 73 placed in the seal housing 62 is weaker than the force applied by the coil spring 31 placed in the seal housing 22, the second valve element 70 moves toward its base-end side, resisting the force applied by the coil spring 73. Following this movement of the second valve element 70, the seal housing 62 elastically changes its shape (see FIG. 6), and a space is formed between the second valve element 70 and the seal housing 62, thereby opening the liquid passage extending from the liquid receiving port 71 to the liquid supply port 65. As a result of the above-described operations, the preparations on the liquid accepter side where the second joint member 50 is provided, for receiving the liquid are completed.

If the male joint part 14 in the state described above is then further inserted into the female joint part 54, the second valve element 70 is locked by the base-end side of the seal housing 62, thereby blocking the movement described above. As a result, the first valve element 30 moves toward its base-end side, resisting the force applied by the coil spring 31. Following this movement, the seal housing 22 elastically changes its shape (see FIG. 6), a space is formed between the first valve element 30 and the seal housing 22, thereby opening the liquid passage extending from the liquid receiving port 23 to the liquid supply port 21.

As a result of the above-described operations, the liquid passage extending from the liquid receiving port 23, via the liquid supply port 21 and then the liquid receiving port 71, to the liquid supply port 65 is opened, and the liquid contained in the liquid reservoir is supplied via the liquid send/receive joint device 1 to the liquid accepter. In this way, the liquid passage for the second joint member 50 placed on the liquid accepter side is first opened, and then the liquid passage for the first joint member 10 placed on the liquid reservoir side is opened. Therefore, it is possible to prevent liquid leakage from between the first joint member 10 and the second joint member 50 when they are connected to each other. Also, since the seal housing 22 and the seal housing 62 are in close contact with each other, the space between the first joint member 10 and the second joint member 50 is sealed with certainty.

When the above-described sequence of operations is performed, the ribs 68A, 68B, 68C, and 68D formed at the female joint part 54 are inserted into the respective spaces between the adjacent engagement protrusions 16A and 16B, 16B and 16C, 16C and 16D, and 16D and 16A formed at the male joint part 14. In this way, centering (positioning) of the male joint part 14 and the female joint part 54 is performed. Also, the engagement hooks 55A, 55B, 55C, and 55D formed on the inside surface of the female joint part 54 respectively engage with the engagement parts 18A, 18B, 18C, and 18D formed on the outside surface of the male joint part 14. As a result, the first joint member 10 and the second joint member 50 are connected to each other stably and optimally.

If the combination of the first joint member 10 and the second joint member 50 is correct when connecting them together, the ribs 68A, 68B, 68C, and 68D are inserted properly into the respective spaces; and if the correct liquid reservoir has not been selected for the liquid accepter, the ribs 68A, 68B, 68C, and 68D will not be inserted properly into the respective spaces. As a result, it is possible to prevent the wrong liquid from being supplied from the wrong liquid reservoir to the liquid accepter. Also, even if a user or a child accidentally attempts to touch the liquid supply part 20 of the first joint member 10 when handling the liquid reservoir, the liquid supply part 20 is protected by the flanges 17A, 17B, 17C, and 17D. Therefore, it is possible to prevent malfunction of the liquid supply part 20. As a result, it is possible to inhibit liquid leakage.

When the first joint member 10 and the second joint member 50 are connected to each other and if the force (rotary force) trying to rotate the first joint member 10 relative to the second joint member 50 is applied to the liquid send/receive joint device 1 and this rotary force reaches a certain level or greater, the ribs 68A, 68B, 68C, and 68D press respectively the outside surfaces of the engagement protrusions 16A, 16B, 16C, and 16D toward their inside surface side, trying to move in the direction of rotation. This pressing force make the engagement protrusions 16A, 16B, 16C, and 16D lean inward because of their elasticity as shown in FIG. 7; and the ribs 68A, 68B, 68C, and 68D move in the direction of rotation along the outside surfaces of the engagement protrusions 16A, 16B, 16C, and 16D; and each rib 68A, 68B, 68C, and 68D is then inserted into the next space. As a result of the above-described operations, the engagement protrusions 16A, 16B, 16C, and 16D are released from the pressing force and return to their original shape (see FIG. 6) because of their elasticity/elastic nature.

When the first joint member 10 and the second joint member 50 are connected to each other, and even if the rotary force of the predetermined level or greater is applied to the liquid send/receive joint device 1 in order to move the first joint member 10 relative to the second joint member 50, the rotary force can be dispersed by having each rib 68A, 68B, 68C, and 68D move to the next space. Then, the ribs 68A, 68B, 68C, and 68D and the engagement protrusions 16A, 16B, 16C, and 16D are released from the rotary force. As a result, it is possible to prevent breakage of the ribs 68A, 68B, 68C, and 68D and the engagement protrusions 16A, 16B, 16C, and 16D due to the rotation.

On the other hand, in order to finish supplying the liquid from the liquid reservoir to the liquid accepter, it is only necessary to remove the first joint member 10 from the second joint member 50. Since the first joint member 10 and the second joint member 50 are connected to each other in a snap-hook manner, the first joint member 10 can be removed from the second joint member 50 easily. Once the first joint member 10 is removed from the second joint member 50, the force applied by the first coil spring 31 causes the first valve element 30 to move toward the top-end side, and the first valve element 30 comes into close contact with the inside wall of the seal housing 22, thereby blocking the liquid passage extending from the liquid receiving port 23 to the liquid supply port 21. At the same time, the seal housing 22 elastically returns to its original shape (as shown in FIGS. 3, 5, and 8) because of its elasticity/elastic nature.

Subsequently, the force applied by the second coil spring 73 moves the second valve element 70 toward the top-end side and the second valve element 70 comes into close contact with the inside wall of the seal housing 62, thereby closing the liquid passage extending from the liquid receiving port 71 to the liquid supply port 65. At the same time, the seal housing 62 elastically returns to its original shape (as shown in FIGS. 4, 5, and 8) because of its elasticity/elastic nature. In this way, the liquid passage for the first joint member 10 placed on the liquid reservoir side is first closed, and then the liquid passage for the second joint member 50 placed on the liquid accepter side is closed. Therefore, it is possible to prevent liquid leakage from between the first joint member 10 and the second joint member 50 when they are disconnected.

This embodiment described the case where four engagement protrusions 16A, 16B, 16C, and 16D are formed as components of the male joint part 14. However, the number of engagement protrusions provided is not limited to this example, and can be decided optionally as long as there are two or more engagement protrusions. Similarly, the number of ribs (insertion parts) can be decided according to the number of spaces to be formed between the engagement protrusions.

This embodiment also described the case where when the engagement protrusions 16A, 16B, 16C, and 16D are made of elastic elements and a rotary force of a predetermined level or greater is applied to at least one of the first joint member 10 and the second joint member 50, the ribs 68A, 68B, 68C, and 68D press the outside surfaces of the engagement protrusions 16A, 16B, 16C, and 16D toward their inside surfaces and make them lean inward. However, the configuration of the engagement protrusions is not limited to this example, and the engagement protrusions 16A, 16B, 16C, and 16D may not necessarily be made of elastic elements. If the engagement protrusions 16A, 16B, 16C, and 16D are not made of elastic elements or are made of a material that hardly elastically changes its shape, it is possible to allow the engagement protrusions 16A, 16B, 16C, and 16D to break before the ribs 68A, 68B, 68C, and 68D, by designing the strength of the ribs 68A, 68B, 68C, and 68D to be greater than the strength of the engagement protrusions 16A, 16B, 16C, and 16D. As a result, breakage of the ribs 68A, 68B, 68C, and 68D can be prevented. Consequently, the life (durability) of the second joint member 50 placed at the liquid accepter can be further extended (enhanced).

As described above, the second joint member 50 placed at the liquid accepter is basically integrated with the main body of an electronic instrument and, therefore, should have a durability (life) similar to that of the main body of the electronic instrument. On the other hand, the first joint member 10 placed at the liquid reservoir is replaced when no liquid to be supplied to the liquid accepter is left in the liquid reservoir. Therefore, a durability as high as that for the second joint member 50 is not required for the first joint member 10. Accordingly, it is desirable that the durability of the second joint member 50 be superior to that of the first joint member 10. This requirement can be satisfied by designing the strength of the ribs 68A, 68B, 68C, and 68D to be greater than that of the engagement protrusions 16A, 16B, 16C, and 16D.

Even if the engagement protrusions 16A, 16B, 16C, and 16D break, the engagement protrusions 16A, 16B, 16C, and 16D are provided for prevention of false connection. Sealability between the first joint member 10 and the second joint member 50 when receiving the liquid is decided by adhesiveness between the seal housing 22 and the seal housing 62. Therefore, the breakage of the engagement protrusions 16A, 16B, 16C, and 16D will not affect sending or receiving of the liquid.

Even if the engagement protrusions 16A, 16B, 16C, and 16D are made of elastic elements, the strength of the ribs 68A, 68B, 68C, and 68D may be designed to be greater than that of the engagement protrusions 16A, 16B, 16C, and 16D. If the engagement protrusions 16A, 16B, 16C, and 16D are made of elastic elements, and when the first joint member 10 and the second joint member 50 rotate relative to each other and each rib 68A, 68B, 68C, and 68D moves to another space located in the direction of rotation, the engagement protrusions 16A, 16B, 16C, and 16D return to their original shape because of their elasticity/elastic nature, so that they can be used repeatedly. Even if the liquid send/receive joint device 1 is placed under conditions where the engagement protrusions 16A, 16B, 16C, and 16D will break, it is possible to prevent breakage of the ribs 68A, 68B, 68C, and 68D.

This embodiment described the case where the ribs 68A, 68B, 68C, and 68D are provided as the insertion parts. However, the configuration of the insertion parts is not limited to this example, and another configuration is possible as long as the insertion parts are inserted into the respective spaces formed between the adjacent engagement protrusions when the female joint part 14 receives the male joint part 54; and when the rotary force less than a predetermined level is applied to the liquid send/receive joint device 1 with the insertion parts inserted in the respective spaces and an attempt is made to rotate the first joint member 10 relative to the second joint member 50, the insertion parts are locked by the engagement protrusions, thereby blocking rotation of the insertion parts; and when the rotary force of the predetermined level or greater is applied to the liquid send/receive joint device 1, the insertion parts are released from the state locked by the engagement protrusions and the rotation can thereby be performed.

Also, this embodiment described the case where the first housing 15 is composed of the base 13 and the male joint part 14. However, the configuration of the first housing 15 is not limited to this example, and the base 13 and the male joint part 14 may be integrally formed as the first housing 15 as long as the first housing 15 has the liquid passage and can contain the first valve element 30.

Furthermore, this embodiment described the case where the second housing 55 is composed of the base 53 and the female joint part 54. However, the configuration of the second housing 55 is not limited to this example, and the base 53 and the female joint part 54 may be integrally formed as the second housing 55 as long as the second housing 55 has the liquid passage and can contain the second valve element 70.

What is claimed is:

1. A liquid send/receive joint device for connecting a liquid reservoir containing a liquid to a liquid accepter for receiving the liquid from the liquid reservoir, the liquid send/receive joint device comprising:
a first joint member that has a male joint part and is placed at either of the liquid reservoir or the liquid accepter; and
a second joint member that has a female joint part to receive the male joint part, is plated at the other of the liquid reservoir and the liquid accepter, and is connected to the first joint member when the female joint part receives the male joint part;
wherein the male joint part has a plurality of engagement protrusions spaced apart from each other; and
the female joint part has insertion parts to be respectively inserted into spaces between the adjacent engagement protrusions when receiving the male joint part; and
wherein when a rotary force less than a predetermined level is applied to the liquid send/receive joint device with the insertion parts inserted in the respective spaces and an attempt is made to rotate the first joint member relative to the second joint member, the insertion parts are locked by the engagement protrusions and the rotation of the insertion parts is thereby blocked; and when a rotary force of the predetermined level or greater is applied to the liquid send/receive joint device, the insertion parts are released from the state locked by the engagement protrusions and performs the rotation.

2. The liquid send/receive joint device according to claim 1, wherein the male joint part is made of an elastic element; and
when the rotary force of the predetermined level or greater is applied to the liquid send/receive joint device, the insertion parts elastically distort the shape of the engagement protrusions, move the engagement protrusions relatively in the direction of rotation, and insert each of the engagement protrusions into a space other than the above located in the direction of rotation.

3. The liquid send/receive joint device according to claim 2, wherein the engagement protrusions are located along the same circle and each engagement protrusion has an inside surface and an outside surface along the circle; and
wherein when the rotary force of the predetermined level or greater is applied to the liquid send/receive joint device, the insertion parts elastically distort the shape of the engagement protrusions so that the engagement protrusions lean inward, and the insertion parts move along the outside surfaces of the engagement protrusions.

4. The liquid send/receive joint device according to claim 1, wherein the first joint member is placed at the liquid reservoir, the second joint member is placed at the liquid accepter, and the strength of the insertion parts is greater than that of the engagement protrusions.

5. The liquid send/receive joint device according to claim 1, wherein the female joint part has a hollow, generally-cylindrical receiving part for receiving the male joint part, and the insertion parts are ribs that protrude from the inside surface of the receiving part toward a central area of the receiving part.

6. The liquid send/receive joint device according to claim 3, wherein regarding the spaces between the adjacent engagement protrusions, the width of each space on the inside surface side of the engagement protrusions is shorter than the width of the space on the outside surface side of the engagement protrusions.

7. The liquid send/receive joint device according to claim 5, wherein the length of each rib along the periphery of the receiving part on its inside surface side is longer than the length of the opposite side of the rib closer to the central area of the receiving part.

8. The liquid send/receive joint device according to claim 1, wherein the first joint member is placed at the liquid reservoir and the second joint member is placed at the liquid accepter:
a liquid supply part that has a liquid supply port and supplies the liquid from the liquid reservoir via the liquid supply port to the second joint member is placed at an approximately central area on the top-end side of the male joint part; and
flanges that protrude toward near the periphery of the liquid supply port are formed at the respective top ends of the engagement protrusions.

9. The liquid send/receive joint device according to claim 1, wherein the first joint member and the second joint member can be connected to each other with snap hocks so that they can be detached from each other whenever necessary.

10. The liquid send/receive joint device according to claim 9, wherein first engagement parts are formed around the outside surface of the male joint part, and second engagement parts that engage with the first engagement part so that they can be detached from each other whenever necessary are formed around the inside surface of the female joint part; and engagement between the first engagement part and the second engagement part causes the first joint member and the second joint member to be connected to each other, while releasing the engagement between the first engagement part and the second engagement part disconnects the first joint member and the second joint member.

11. A fuel cell system comprising:
a fuel cell;
a liquid reservoir containing liquid fuel;
a liquid accepter for receiving the liquid fuel from the liquid reservoir and supplying it to the fuel cell, and
the liquid send/receive joint device described in any one of claims 1 to 10.

12. The fuel cell system according to claim 11, wherein the liquid fuel contains methanol.
